(19) United States
(12) Patent Application Publication
(10) Pub. No.: US 2015/0262238 A1
(43) Pub. Date: Sep. 17, 2015

(54) Techniques for Topic Extraction Using Targeted Message Characteristics

(71) Applicant: Adobe Systems Incorporated, San Jose, CA (US)

(72) Inventors: Cory Aitchison, American Fork, UT (US); Mark Lanett, San Francisco, CA (US); Paul Jones, Lehi, UT (US)

(73) Assignee: Adobe Systems Incorporated, San Jose, CA (US)

(21) Appl. No.: 14/216,579

(22) Filed: Mar. 17, 2014

(51) Int. Cl. G06Q 30/02; G06F 17/30; H04L 12/58; G06F 17/27

(52) U.S. Cl. CPC G06Q 30/0263; G06F 17/2785; G06F 17/30699; H04L 51/046

(57) ABSTRACT

Disclosed are various embodiments for obtaining messages from content sites accessible via a network. Filtered messages are identified from the messages using filter criteria to identify ones of the messages having one or more characteristics relevant for a particular marketing circumstance. A topic is selected based on determining that multiple occurrences of the filtered messages relate to the topic. Based on selecting the topic, recommending the topic for targeted marketing in the identified marketing circumstance.

### BACKGROUND

People may use various messaging services to exchange and/or store messages, some of which concern, at least in part, various products and services with which they have used or interacted. The messages may be stored in a variety of forms such as a product review on a content site (e.g. web site) of a retailer, a posting to a personal page of a content site (e.g. FACEBOOK), a comment posted in response to a posting on a content site (e.g. a blog), product feedback given to a product manufacturer, and/or other possible sources of messages as can be appreciated.

### SUMMARY OF THE INVENTION

The disclosed embodiments relate to techniques for extracting topics from among a collection of messages. In an embodiment, electronic messages provided by users are obtained from various content sites. The messages are filtered using filter criteria to identify messages exhibiting one or more characteristics relevant for an identified marketing circumstance. The content of the filtered messages is analyzed to discover the topics present in the filtered messages. One or more of these topics are selected based on various determinations. A topic may be selected if the occurrences of filtered messages that relate to the topic are greater than occurrences of filtered messages that relate to another topic, the occurrences of filtered messages that relate to the topic meet a threshold, the topic is related to a previously identified topic, and/or under other possible circumstances. The one or more selected topics are recommended for targeted marketing in the identified marketing circumstance.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment according to an embodiment of the present disclosure.

FIG. 2 is a pictorial diagram of an example user interface rendered by a client in the networked environment of FIG. 1 according to an embodiment of the present disclosure.

FIG. 3 is a flowchart illustrating one example of functionality implemented as a portion of a message analysis service executed in a server device in the networked environment of FIG. 1 according to an embodiment of the present disclosure.

FIG. 4 is a flowchart illustrating another example of functionality implemented as a portion of a message analysis service executed in a server device in the networked environment of FIG. 1 according to an embodiment of the present disclosure.

FIG. 5 is a flowchart illustrating yet another example of functionality implemented as a portion of a message analysis service executed in a server device in the networked environment of FIG. 1 according to an embodiment of the present disclosure.

FIG. 6 is a flowchart illustrating still another example of functionality implemented as a portion of a message analysis service executed in a server device in the networked environment of FIG. 1 according to an embodiment of the present disclosure.

FIG. 7 is a flowchart illustrating still another example of functionality implemented as a portion of a message analysis service executed in a server device in the networked environment of FIG. 1 according to an embodiment of the present disclosure.

FIG. 8 is a schematic block diagram that provides one example illustration of a server device employed in the networked environment of FIG. 1 according to an embodiment of the present disclosure.

### DETAILED DESCRIPTION

It may be desirable to collect messages that people provide which concern a particular product or service in order to distill the topics of comments associated with the products or services. However, given the volume of messages created and various message criteria specified, among other reasons, it may be impossible or impracticable for a person to capture and comprehend the topics of the sought messages. Nonetheless, vendors may wish to be aware of the particular topics collectively expressed by comments and assessments of the products and services that appear within those messages. The topics may in turn be used to create marketing materials emphasizing, for example, only the most well-regarded aspects of the product or service. Without knowledge of these topics, the effectiveness of tasks such as product marketing may be impaired.

In order to facilitate effective marketing and other activities for vendors, only those messages matching a set of desired characteristics may be analyzed to extract topics of interest for marketing recommendations. The characteristics used to filter the messages may be selected based on the particular goals for the particular marketing circumstance. For example, if a vendor seeks to advertise the most well-liked changes to a new version of a product, the messages may be filtered using characteristics to include only messages that have a positive user sentiment and that were created since the new product version was introduced. In this way, topics extracted from these filtered messages (e.g. new product styling) will have the desired characteristics (i.e. positive feelings about the new styling) and will be relevant to the particular marketing recommendation.

To this end, in an embodiment, the messages created by various users are first obtained from the various content sites (e.g. blogs, social media sites, etc.) through which the messages are exchanged and/or stored. A subset of the messages of interest are selected from among general messages present in the content sites by filtering using a set of keywords and/or other search terms. For example, if a marketing recommendation is sought concerning a particular product, only messages that mention the particular product need to be considered for evaluation. The messages are then analyzed to identify various message characteristics such as sentiment scores (e.g. positive or negative attitude), emotion scores (e.g. angry, happy, sad, etc.), age of the messages, source of the messages, detected languages (e.g. English, Spanish, Mandarin), legitimacy scores (i.e. anti-spam), and/or other possible characteristics.

As discussed above, the messages are then narrowed using filter criteria to identify the filtered messages exhibiting one or more characteristics relevant to the goals sought for the particular marketing recommendation. Once the set of filtered messages having the desired characteristics is determined, the content of the filtered messages is analyzed to discover topics expressed in the filtered messages. One or more of the potential topics are selected based on determining the existence of multiple filtered messages that relate to the topic. For example, a topic may be selected because it is the topic of a relatively high percentage of the filtered messages (i.e. many of the messages relate to the topic). A topic may be selected if it is considered “common” based on the occurrences of filtered messages that relate to the topic being greater than occurrences of filtered messages that relate to another potential topic, the occurrences of filtered messages that relate to the topic meeting a threshold, and/or other possible circumstances. Additionally, a topic may be selected if it relates to another previously identified topic, such as, a topic of particular interest specified by a user, a previously identified common topic, etc. Thereafter, a targeted marketing recommendation is provided based on the selected topic(s) distilled from the filtered messages. Since the filtered messages have the characteristics sought for a marketing recommendation, the topic(s) expressed in the filtered messages should also reflect these characteristics.

Throughout the disclosure, the following terms may be used and should be given the following meaning.

A “sentiment score” is a score indicating the strength and presence of positive or negative emotion based on the words chosen by a user as an author of a given message.

An “emotion score” is a score indicating the one or more emotions (e.g. angry, happy, sad, etc.) associated with the words chosen by a user and provides a higher-order variation of detected emotion rather than the binary “positive” or “negative” emotion of the sentiment score.

A “topic” is a subject matter or theme present in a plurality messages that may be identified through natural language analysis and/or other techniques. For instance, based on messages obtained from comments to a sports blog, the topics extracted from the discussions in the messages may be team names, player names, favorite games, favorite moments in games, etc. A “common topic” is a topic determined to be of particular interest, with respect to a marketing circumstance, based on occurrences of filtered messages that relate to the topic. For example, common topics may include the topic that is identified in the greatest number of filtered messages analyzed, the topics that are identified in at least 10% of the filtered messages, etc.

The “message characteristics” include various attributes and metadata for each of the respective messages. For example, message characteristics for a given message may include a sentiment score (e.g. positive or negative attitude), age of message, emotion score (e.g. angry, happy, sad, etc.), source of message, detected language (e.g. English, Spanish, Mandarin, etc.), personal/demographic information about the author, legitimacy scores (i.e. anti-spam), and/or other possible characteristics.

A “marketing circumstance” is the set of various factors associated with marketing a product or service. A marketing circumstance may specify the product or service to be marketed, characteristics of topics sought for the marketing, criteria for identifying topics, relational topics sought for the marketing, and/or other possible marketing factors. For example, a marketing circumstance may specify that the most popular topics about a particular product to be marketed are sought, where the most popular topics are determined from among only those topics about which users of the product are happy or excited. The marketing circumstance can also specify one or more relational topics of particular interest, whereby the relational topics are used to identify other related topics, which may or may not be common. In response to performing message analysis upon a set of messages as specified by a marketing circumstance, a recommendation for targeted marketing (i.e. a “marketing recommendation”) may be provided.

A “marketing recommendation” is a proposal of one or more topics for use as a subject of a targeted marketing campaign. The topics of a particular marketing recommendation are derived from a set of messages having the message characteristics relevant for a particular marketing circumstance. For example, if a marketing recommendation is sought regarding a recently updated product version, messages concerning the product may be filtered based on message characteristics to include only those messages created since the new version of the product was introduced and that express happiness or excitement. From these messages matching the criteria (i.e. the “filtered messages”), the topics expressed in the filtered messages may be extracted and provided in the market recommendation.

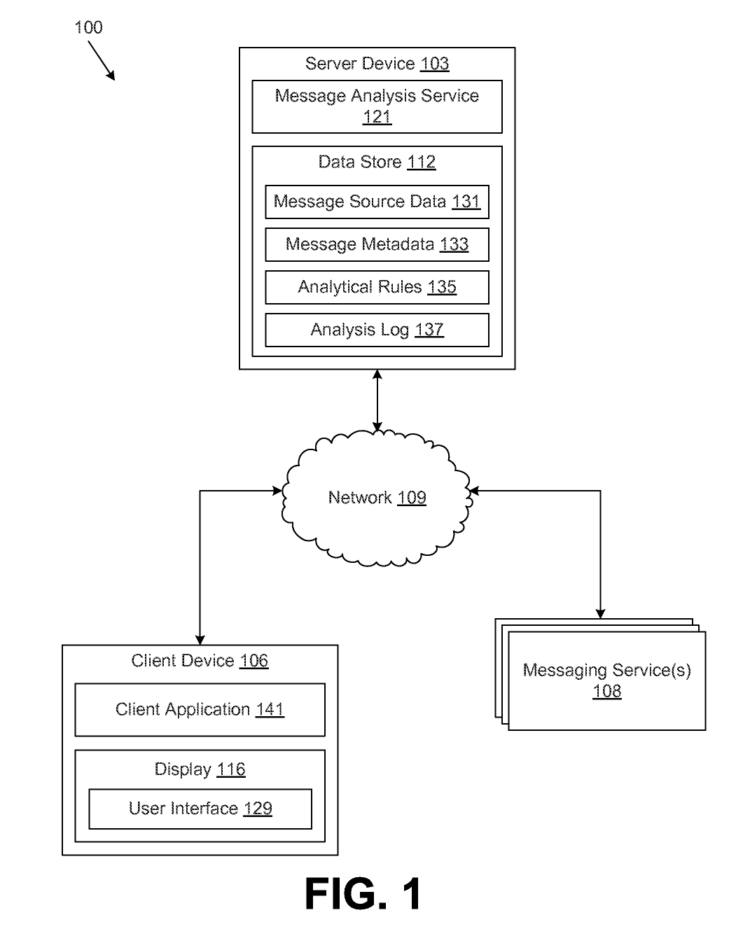

In the following discussion, a general description of the system and its components is provided, followed by a discussion of the operation of the same. With reference to FIG. 1, shown is a networked environment 100 according to various embodiments. The networked environment 100 includes a server device 103, a client device 106, and messaging services 108, which are in data communication with each other via a network 109. The network 109 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The server device 103 may comprise, for example, a server computer or any other system providing computing capability. Alternatively, the server device 103 may employ a plurality of computing devices that may be arranged, for example, in one or more server banks or computer banks or other arrangements. Such computing devices may be located in a single installation or may be distributed among many different geographical locations. For example, the server device 103 may include a plurality of computing devices that together may comprise a hosted computing resource, a grid computing resource and/or any other distributed computing arrangement. In some cases, the server device 103 may correspond to an elastic computing resource where the allotted capacity of processing, network, storage, or other computing-related resources may vary over time.

Various applications and/or other functionality may be executed in the server device 103 according to various embodiments. Also, various data is stored in a data store 112 that is accessible to the server device 103. The data store 112 may be representative of a plurality of data stores 112 as can be appreciated. The data stored in the data store 112, for example, is associated with the operation of the various applications and/or functional entities described below.

The components executed on the server device 103, for example, include a message analysis service 121, and other applications, services, processes, systems, engines, or functionality not discussed in detail herein. The message analysis service 121 is executed to determine one or more topics associated with a collection of messages. The topics derived from the messages may later be provided to recipients in order to facilitate other activities. In some embodiments, the message analysis service 121 may also perform some retrieval, character analysis, and/or filtering of messages prior to extracting topics associated with the collection of messages.

The message analysis service 121 may be configured for operation using data available in the data store 112. In various embodiments, all or portions of the configuration of the message analysis service 121 may also be received as input through a user interface in communication with the message analysis service 121. The user interface may be local to the server device 103 and/or may communicate with the message analysis service 121, via the network 109, using hypertext transfer protocol (HTTP), HTTP Secure (HTTPS), remote procedure call (RPC), simple object access protocol (SOAP), and/or other data communication protocols as can be appreciated.

The data stored in the data store 112 includes, for example, message source data 131, message metadata 133, analytical rules 135, an analysis log 137, and potentially other data. The message source data 131 may include a specification of the uniform resource identifiers (URIs) and/or other network addresses of content sites to be used as sources of the messages to be examined, criteria for retrieving messages from the content sites, messages previously obtained from the content sites, and/or other possible data. The message metadata 133 may include various characteristics associated with the messages that have been previously examined. The characteristics may be generated by the message analysis service 121 and may include, for example, sentiment scores (e.g. positive or negative attitude), emotion scores (e.g. angry, happy, sad, etc.), detected languages (e.g. English, Spanish, Mandarin), legitimacy scores (i.e. anti-spam), and/or other possible characteristics as can be appreciated.

The analytical rules 135 may specify various characteristics and/or other metadata associated with the messages to be examined for topic extraction. As a non-limiting example, the analytical rule 135 may specify that the only messages that should be examined for topics are those messages having a positive sentiment score and that also have an emotion score indicating the author of the message was happy or excited. The analysis log 137 is a record of the various activities associated with identifying characteristics of the messages and examining selected ones of the messages for topic extraction. The analysis log 137 may include the topics that were identified by examining the messages, an indication of the ones of the messages associated with the topics, a confidence score associated with each of the topics, and/or other possible data as can be appreciated.

The client 106 is representative of a plurality of client devices that may be coupled to the network 109. The client 106 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client 106 may include a display 116. The display 116 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client 106 may be configured to execute various applications such as a client application 141 and/or other applications. The client application 141 may be executed in a client 106, for example, to access network content served up by the server device 103 and/or other servers, thereby rendering a user interface 129 on the display 116. To this end, the client application 141 may comprise, for example, a browser, a dedicated application, etc., and the user interface 129 may comprise a network page, an application screen, etc. In some embodiments, all or portions of the configuration of the message analysis service 121 may also be received as input through the user interface 129 of the client application 141. The client 106 may be configured to execute applications beyond the client application 141 such as, for example, email applications, social networking applications, word processors, spreadsheets, and/or other applications.

The messaging service 108 represents one or more messaging services executed by a computing device that may receive messages via the network 109. As a non-limiting example, the messaging service 108 may be a content site (e.g. a website), simple mail transport protocol (SMTP) gateway, a short message service/multimedia message service (SMS/MMS) gateway, a proprietary message gateway (e.g. TWITTER, FACEBOOK, etc.), and/or another possible messaging interface. In some embodiments, a portion of the messages available through the messaging service 108 may not be accessible publicly and/or may require user authentication prior to being accessible. For example, a message may be a comment provided to a content site for a product manufacturer. In some instances, the comment may be visible only to select users authorized by the product manufacturer.

Next, a general description of the operation of the various components of the networked environment 100 is provided. To begin, people may use the messaging services 108 to exchange and/or store “general messages,” some of which concern, at least in part, various products and services with which they have used or interacted. The messages may be stored in a variety of forms such as a product review on a content site (e.g. web site) of a retailer, a posting to a personal page of a content site (e.g. FACEBOOK), a comment posted in response to a posting on a content site (e.g. a blog), product feedback given to a product manufacturer, and/or other possible sources of messages as can be appreciated. For many possible reasons, it may be desirable to collect those messages that may concern a particular product or service in order to distill the topics of comments associated with the products or services. The message analysis service 121 may be employed to perform the tasks associated with extracting topics from a group of messages.

The message source data 131 may include the general messages to be analyzed and/or may specify the locations (e.g. URIs) where such messages may be obtained. In some embodiments, the message source data 131 and/or user interface 129 may also specify criteria with which the message analysis service 121 may reduce the number of general messages to a smaller set of “selected messages” in order to narrow the number of messages to be analyzed. The criteria to be used for comparison may include keywords, regular expressions, audio, video, images, times/dates, usernames, and/or other possible criteria. Such reduction may be particularly useful if, for instance, the set of messages to be analyzed by the message analysis service 121 would otherwise include a substantial number of messages that do not comment upon or are not associated with the particular product or service sought.

The messages selected for analysis may then be evaluated by the message analysis service 121 for various language characteristics such as sentiment (e.g. positive/negative feeling), emotion (e.g. angry, happy, etc.), detected language system (e.g. English, Spanish, etc.), legitimacy (i.e. spam detection), and/or other possible characteristics. As can be appreciated by one skilled in the art, various natural language processing techniques may be used to evaluate some of these characteristics to produce, for example, sentiment scores, emotion scores, etc. The characteristics determined for individual ones of the messages may then be stored in the message metadata 133.

Thereafter, all or portions of the selected messages may be analyzed by the message analysis service 121 to extract the topics present in the messages. In an embodiment, the selected messages are further filtered based on the characteristics and/or other message metadata specified by the analytical rules 135 and/or user interface 129. Such filtering may be useful in order to analyze only those messages (i.e. “filtered messages”) associated with particular products or services that also exhibit the desired characteristics.

As a non-limiting example, a product manufacturer may desire to capture and emphasize the most well-liked aspects of a new product within upcoming marketing materials. To this end, the manufacturer may wish to select only those messages from various users and sources that comment upon the new product. Each of those selected messages may then be evaluated to determine the respective characteristics. Given that the manufacturer is seeking only the well-liked aspects of the product, the selected messages are filtered to include only those messages having positive sentiment scores and emotion scores indicating that the user is happy, excited, etc. about the product experience. In conclusion of this example, the filtered messages may then be analyzed to identify those topics or aspects of the product that are associated with positive comments from the messages.

Returning to the description, once the set of filtered messages has been identified according to the characteristics specified in the analytical rules 135 and/or user interface 129, the message analysis service 121 may begin the topic extraction operations upon these filtered messages through use of the k-means clustering algorithm and/or other natural language processing techniques.

Thereafter, the message analysis service 121 selects one or more topics for which multiple occurrences of the filtered messages relate to the topics. The topics may be selected on the basis of being “common” among the filtered messages. A particular topic may be identified as “common” if the occurrences of filtered messages that relate to the topic are greater than occurrences of filtered messages that relate to another topic, if the occurrences of filtered messages that relate to the topic meet a threshold, and/or under other possible circumstances specified by the analytical rules 135 and/or user interface 129. In addition, a portion of the topics may be selected on the basis of being related to a previously identified topic. The previously identified topic may be identified based on a user defining a marketing circumstance, based on analytic information collected about the marketing circumstance, based on user input identifying potential topics, based on a prior determination by the message analysis service 121, etc.

The one or more topics selected by the message analysis service 121, as well as possibly the filtered messages contributing to each selected topic, the source of the respective messages, and/or other metadata associated with the messages may be stored in the analysis log 137 and/or presented in the user interface 129. In some embodiments, the selected topics may be provided to one or more recipients and may be delivered via the network 109 to these recipients.

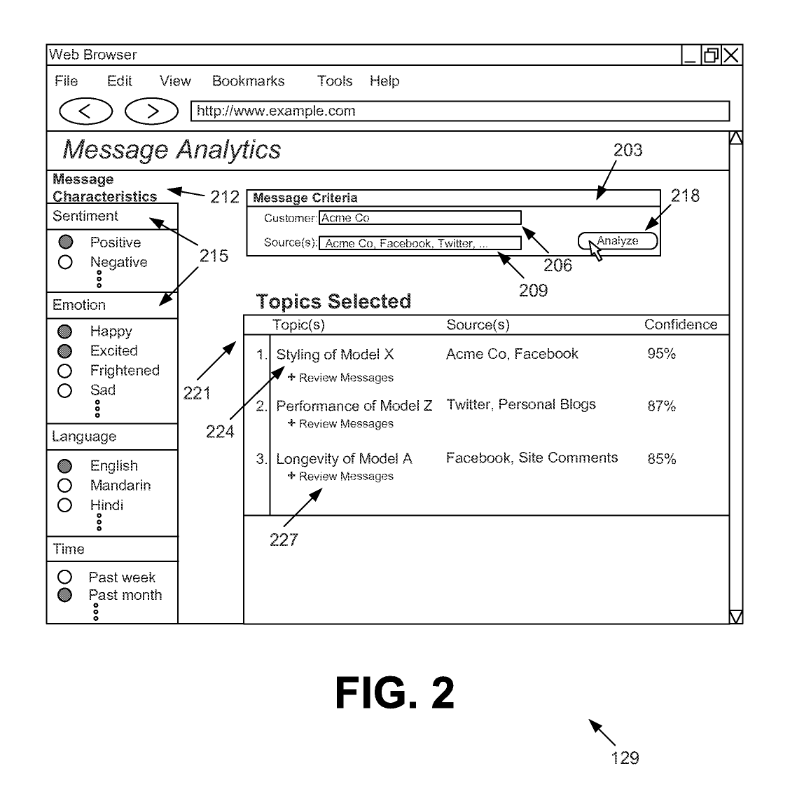

Referring next to FIG. 2, shown is an illustrative example of a user interface, denoted herein as user interface 129 (FIG. 1) encoded by the message analysis service 121 (FIG. 1) and rendered by a client application 141 (FIG. 1) executed by a client 106 (FIG. 1). Within the user interface 129 of FIG. 2, a message criteria panel 203 may be included from which various data associated with the selected messages may be presented to and/or edited by a user. In this regard, a customer region 206 may be available from which a particular customer may be entered or selected, thereby facilitating analysis of the messages associated with the particular customer. Additionally, a source region 209 may be included in the criteria panel 203, wherein the source region 209 may permit changes to the source(s) of messages associated with the customer that are available for analysis. In some embodiments, the source(s) of messages may be predefined for each customer such that the source region is prepopulated with the predefined sources based upon selection of a customer.

The message characteristics panel 212 may permit a user to select the various types of message characteristics they wish to have exhibited by the messages to be analyzed. The message characteristics panel 212 may include one or more characteristic regions 215 that provide options applicable to each of the characteristics represented by the respective characteristic region 215. Upon selecting the desired characteristics, the analysis may be initiated by selecting the “analyze” region 218 shown within the criteria panel 203. In some embodiments, some or all of the analysis to be performed may be carried out prior to selecting the options of the characteristics, may be carried out using a set of common options, may begin in response to an option being selected, and/or other possibilities as can be appreciated.

The result of the analysis may be presented in the topics panel 221. Within the topics panel 221, a topic region 224 may be presented for each selected topic identified from the analyzed messages. Each of the topic regions 224 may provide a brief description of the topic, the sources of the particular messages from which the topic was derived, and/or other possible information about the topic. In addition, the topic regions 224 may provide a review region 227 that permits a user to review some or all of the message that contributed to a particular topic. The selected topics may be presented to provide a marketing recommendation. For example, a topic may pertain to a particular feature of a product that consumers found appealing and, by identifying the topic as a common topic, it may suggest to an advertiser to focus an advertisement campaign touting that particular feature. The topics panel 221 could be presented as a marketing recommendation panel 221 or alternative or additional panels, windows, or user interface features could be used to provide one or more marketing recommendations based on the selected topics.

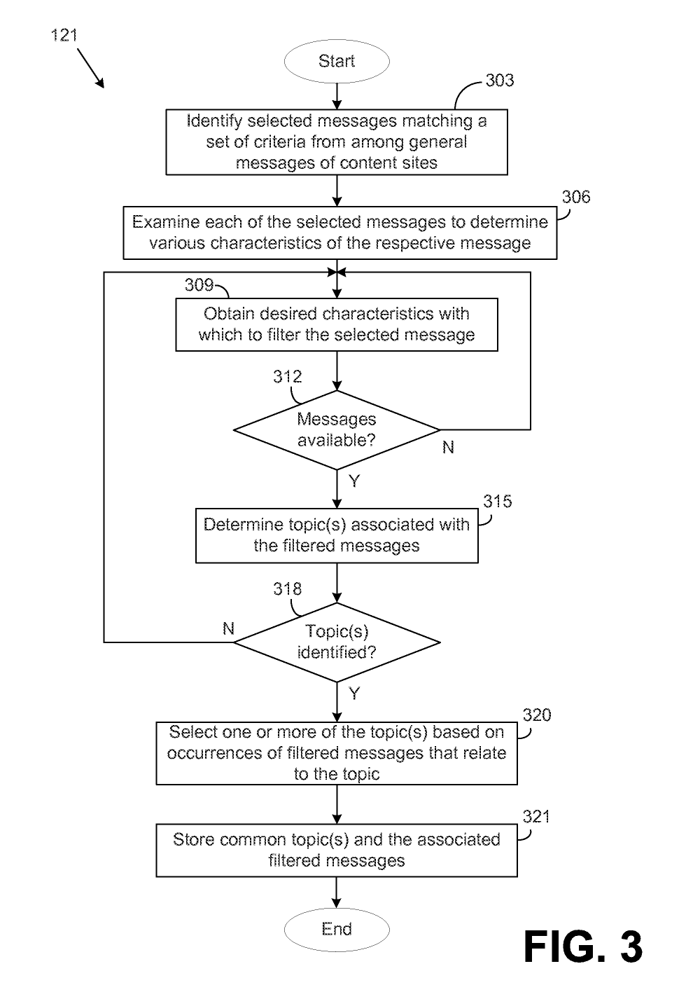

Referring next to FIG. 3, shown is a flowchart that provides one example of the operation of a portion of the message analysis service 121 according to various embodiments. It is understood that the flowchart of FIG. 3 provides merely an example of the many different types of functional arrangements that may be employed to implement the operation of the portion of the message analysis service 121 as described herein. As an alternative, the flowchart of FIG. 3 may be viewed as depicting an example of elements of a method implemented in the server device 103 (FIG. 1) according to an embodiment.

This portion of the execution of the message analysis service 121 may be initiated in response to a request to perform a topic analysis upon a set of general messages. Beginning with block 303, the message analysis service 121 may reduce the number of general messages to a smaller set of selected messages in order to narrow the number of messages to be analyzed. The criteria used for the reduction may be specified by the message source data 131 and/or user interface 129. The criteria to be used for comparison may include keywords, regular expressions, audio, video, images, times/dates, usernames, and/or other possible criteria. Such reduction may be particularly useful if, for instance, the set of messages to be analyzed by the message analysis service 121 would otherwise include a substantial number of messages that do not comment upon or are not associated with the particular product or service sought.

Next, in block 306, the message analysis service 121 may then evaluate the selected messages for various language characteristics such as sentiment, emotion, detected language system, legitimacy, and/or other possible characteristics. As can be appreciated by one skilled in the art, various natural language processing techniques may be used to evaluate some of these characteristics to produce, for example, sentiment scores, emotion scores, etc. The characteristics determined for individual ones of the messages may then be stored in the message metadata 133.

Then, in block 309, the message analysis service 121 may obtain the desired characteristics specified in the analytical rules 135 and/or user interface 129 of the messages of the messages to be analyzed. Thereafter, the message analysis service 121 may filter the selected messages based on the characteristics and/or other message metadata specified by the analytical rules 135 and/or user interface 129.

Continuing, in block 312, the message analysis service 121 may determine whether messages remain to be analyzed after performing the filtering. If an insufficient number of messages remain based upon the filter options specified, then execution of the message analysis service 121 may return to block 309 to modify the filter options. Alternatively, in block 315, the message analysis service 121 may begin the topic extraction operations upon these filtered messages through use of the k-means clustering algorithm and/or other natural language processing techniques.

Next, in block 318, the message analysis service 121 determines whether topics were extracted during analysis of the filtered messages. If no topics were identified, then execution of the message analysis service 121 returned to block 309 where filter options may be adjusted. Alternatively, if topics were identified within the filtered messages, in block 320, the message analysis service 121 may select one or more of the topics based on occurrences of filtered messages that relate to the topic. A topic may be selected if the occurrences of filtered messages that relate to the topic are greater than occurrences of filtered messages that relate to another topic, if the occurrences of filtered messages that relate to the topic meet a threshold, if the topic relates to another previously identified topic, and/or under other possible circumstances.

For example, upon analyzing a set of filtered messages concerning a product, ten topics may be identified. Some of the topics may only be identified within a small number of the filtered messages, while other topics (i.e. the common topics) may be identified in a larger number of the filtered messages. The topics may be selected by the message analysis service 121 on the basis of being “common” among the filtered messages. The number of filtered messages in which the topic appears before being identified as a “common topic” may be based on a threshold number of matching filtered messages (e.g. the topic appears in 20+% of the filtered messages). Alternatively, a topic may be identified as common if it is identified within more filtered messages than another topic (e.g. the top 5 most popular topics). In addition, a portion of the topics may be selected by the message analysis service 121 on the basis of being related to a previously identified topic (e.g. a topic of particular interest previously identified by a user).

Continuing, in block 321, the message analysis service 121 may store and/or present the one or more selected topics, as well as possibly the filtered messages contributing to each selected topic, the source of the respective messages, and/or other metadata associated with the messages and the selected topics. Thereafter, this portion of the execution of the message analysis service 121 may end as shown.

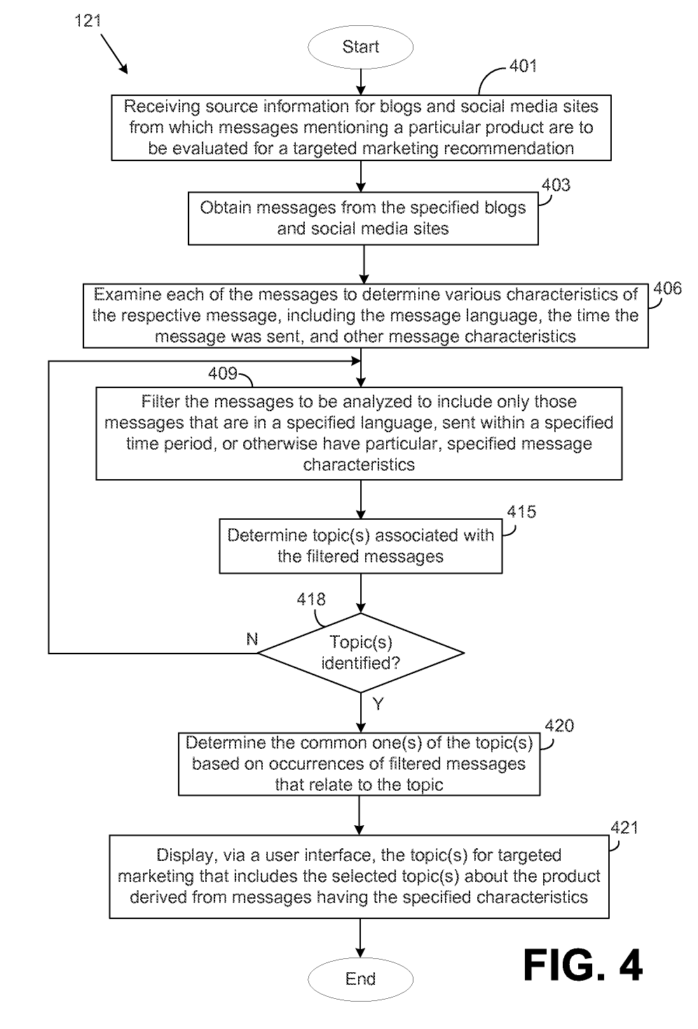

Referring next to FIG. 4, shown is a flowchart that provides another example of the operation of a portion of the message analysis service 121 according to an embodiment. It is understood that the flowchart of FIG. 4 provides merely an example of the many different types of functional arrangements that may be employed to implement the operation of the portion of the message analysis service 121 as described herein. As an alternative, the flowchart of FIG. 4 may be viewed as depicting an example of elements of a method implemented in the server device 103 (FIG. 1) according to an embodiment.

This portion of the execution of the message analysis service 121 may be initiated in response to a request to produce a marketing recommendation for a particular product. Beginning with block 401, the message analysis service 121 receives source information (e.g. URIs) for network sites such as blogs, social media sites, etc. from which messages should be obtained. Then, in block 403, the message analysis service 121 obtains the messages from the specified blogs and social media sites. As described previously, the source information may further include keywords, regular expressions, etc. that may be used to match or exclude particular messages from initial consideration for the marketing recommendation. Such reduction may be particularly useful if, for instance, the set of messages to be analyzed by the message analysis service 121 would otherwise include a substantial number of messages that do not comment upon or are not associated with the particular product sought.

Next, in block 406, the message analysis service 121 then evaluates each of the selected messages to determine various characteristics of the respective message, such as the message language, the time message was sent, and other possible characteristics. The characteristics determined for individual ones of the messages may then be stored in the message metadata 133. Then, in block 409, the message analysis service 121 receives the desired characteristics limiting the messages to be analyzed to only those messages that are in a specified language, sent within a specified time period, or otherwise have particular, specified message characteristics. The desired characteristics may specified in the analytical rules 135 and/or user interface 129 of the messages of the messages to be analyzed. Thereafter, the message analysis service 121 may filter the selected messages based on the characteristics and/or other message metadata specified by the analytical rules 135 and/or user interface 129.

Continuing, in block 415, the message analysis service 121 begin the topic extraction operations upon the messages matching the desired characteristics through use of the k-means clustering algorithm and/or other natural language processing techniques. Next, in block 418, the message analysis service 121 determines whether topics were extracted during analysis of the filtered messages. If no topics were identified, then execution of the message analysis service 121 returns to block 409 where filter options may be adjusted. Alternatively, if topics were identified within the filtered messages, in block 420, the message analysis service 121 may select one or more of the common topics based on occurrences of filtered messages that relate to the topic. A topic may be considered a common topic if the occurrences of filtered messages that relate to the topic are greater than occurrences of filtered messages that relate to another topic, if the occurrences of filtered messages that relate to the topic meet a threshold, and/or under other possible circumstances.

Continuing, in block 421, the message analysis service 121 presents, in a user interface, the one or more common topics that have been selected, as well as possibly the filtered messages contributing to each common topic, the source of the respective messages, and/or other metadata associated with the messages and the common topics. Thereafter, this portion of the execution of the message analysis service 121 ends as shown.

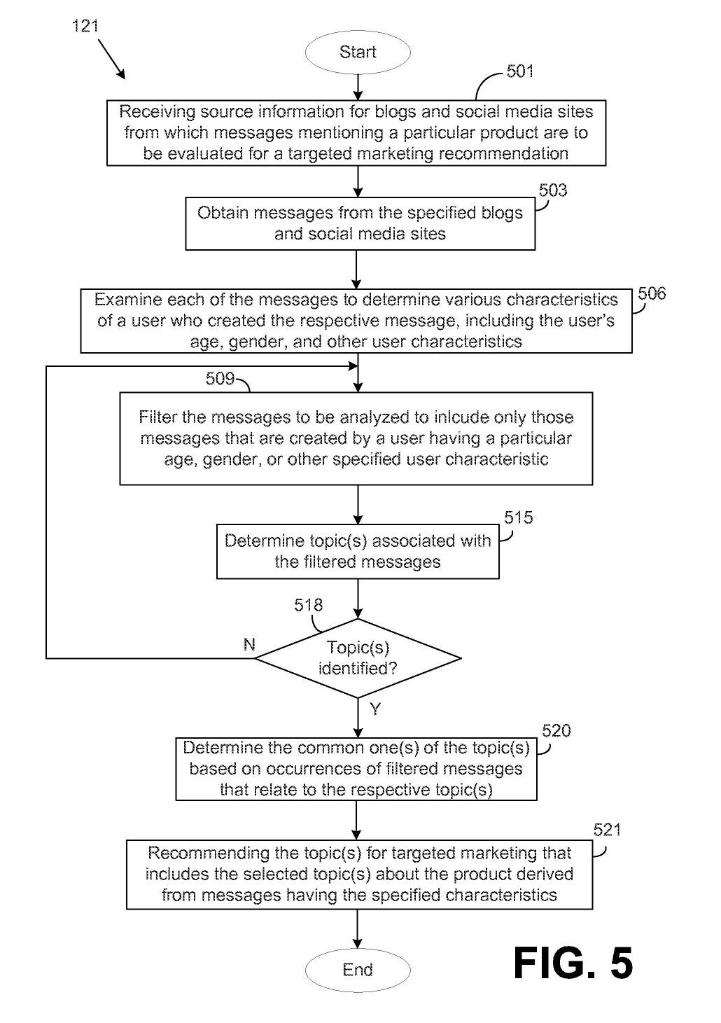

Referring next to FIG. 5, shown is a flowchart that provides yet another example of the operation of a portion of the message analysis service 121 according to an embodiment. It is understood that the flowchart of FIG. 5 provides merely an example of the many different types of functional arrangements that may be employed to implement the operation of the portion of the message analysis service 121 as described herein. As an alternative, the flowchart of FIG. 5 may be viewed as depicting an example of elements of a method implemented in the server device 103 (FIG. 1) according to an embodiment.

This portion of the execution of the message analysis service 121 may be initiated in response to a request to produce a marketing recommendation for a particular product. Beginning with block 501, the message analysis service 121 receives source information (e.g. URIs) for network sites such as blogs, social media sites, etc. from which messages should be obtained. Then, in block 503, the message analysis service obtains the messages from the specified blogs and social media sites. As described previously, the source information may further include keywords, regular expressions, etc. that may be used to match or exclude particular messages from initial consideration for the marketing recommendation.

Next, in block 506, the message analysis service 121 then evaluates each of the selected messages to determine various characteristics of the user who created the respective message, such as the age of the user, gender, and other user characteristics. The characteristics determined for individual ones of the messages may then be stored in the message metadata 133. Then, in block 509, the message analysis service 121 receives the desired characteristics for limiting the messages to be analyzed to only those messages that are created by a user having a particular age, gender, or other specified user characteristic. The desired characteristics may specified in the analytical rules 135 and/or user interface 129 of the messages of the messages to be analyzed. Thereafter, the message analysis service 121 may filter the selected messages based on the characteristics and/or other message metadata specified by the analytical rules 135 and/or user interface 129.

Continuing, in block 515, the message analysis service 121 begin the topic extraction operations upon the messages matching the desired characteristics through use of the k-means clustering algorithm and/or other natural language processing techniques. Next, in block 518, the message analysis service 121 determines whether topics were extracted during analysis of the filtered messages. If no topics were identified, then execution of the message analysis service 121 returns to block 509 where filter options may be adjusted. Alternatively, if topics were identified within the filtered messages, in block 520, the message analysis service 121 may select the common topics from among the topics identified, as described previously. Then, in block 521, the message analysis service 121 recommends the one or more selected topics concerning the product to a customer, where the topics are based on the messages having the specified characteristics. Thereafter, this portion of the execution of the message analysis service 121 ends as shown.

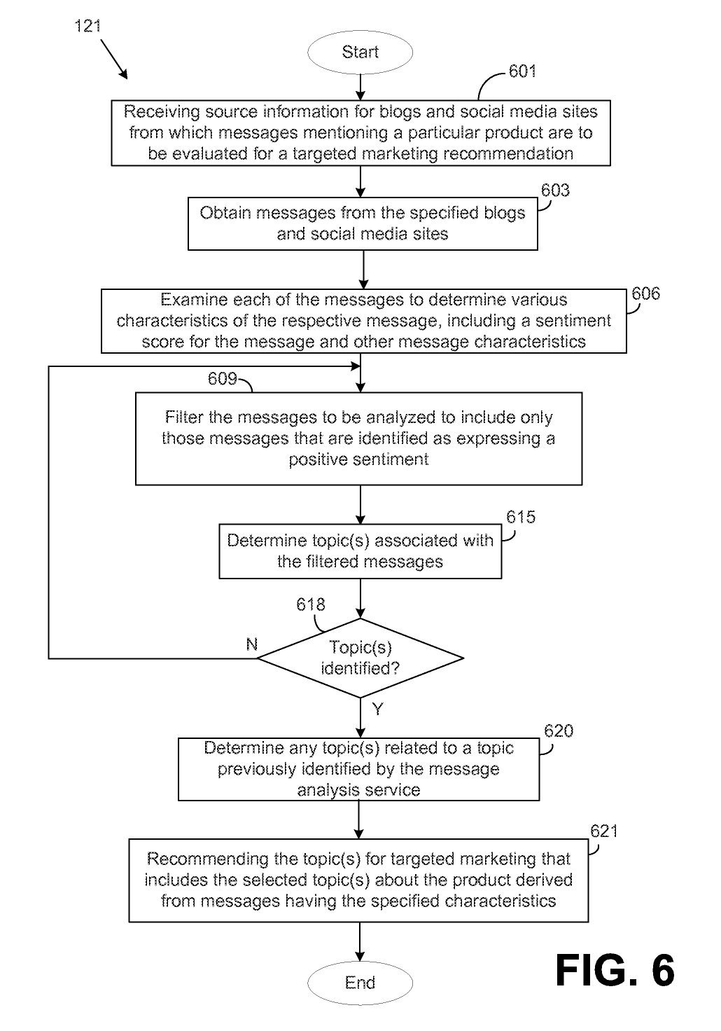

Referring next to FIG. 6, shown is a flowchart that provides still another example of the operation of a portion of the message analysis service 121 according to an embodiment. It is understood that the flowchart of FIG. 6 provides merely an example of the many different types of functional arrangements that may be employed to implement the operation of the portion of the message analysis service 121 as described herein. As an alternative, the flowchart of FIG. 6 may be viewed as depicting an example of elements of a method implemented in the server device 103 (FIG. 1) according to an embodiment.

This portion of the execution of the message analysis service 121 may be initiated in response to a request to produce a marketing recommendation for a particular product. Beginning with block 601, the message analysis service 121 receives source information (e.g. URIs) for network sites such as blogs, social media sites, etc. from which messages should be obtained. Then, in block 603, the message analysis service obtains the messages from the specified blogs and social media sites. As described previously, the source information may further include keywords, regular expressions, etc. that may be used to match or exclude particular messages from initial consideration for the marketing recommendation.

Next, in block 606, the message analysis service 121 then evaluates each of the selected messages to determine various characteristics of the respective message, such as a sentiment score and other possible characteristics. The characteristics determined for individual ones of the messages may then be stored in the message metadata 133. Then, in block 609, the message analysis service 121 receives the desired characteristics limiting the messages to be analyzed to only those messages that have a positive sentiment score or otherwise have particular, specified message characteristics. The desired characteristics may specified in the analytical rules 135 and/or user interface 129 of the messages of the messages to be analyzed. Thereafter, the message analysis service 121 may filter the selected messages based on the characteristics and/or other message metadata specified by the analytical rules 135 and/or user interface 129.

Continuing, in block 615, the message analysis service 121 begin the topic extraction operations upon the messages matching the desired characteristics through use of the k-means clustering algorithm and/or other natural language processing techniques. Next, in block 618, the message analysis service 121 determines whether topics were extracted during analysis of the filtered messages. If no topics were identified, then execution of the message analysis service 121 returns to block 609 where filter options may be adjusted. Alternatively, if topics were identified within the filtered messages, in block 620, the message analysis service 121 determines whether identified topics are related to one or more topics previously found.

For example, the message analysis service 121 may have previously identified a common topic from among a set of filtered messages. If the message analysis service 121 later discovers a topic that is related to the previously identified common topic, the related topic may also be selected for use in a marketing recommendation based on the relationship to a common topic. As an example, “skiing” is previously identified as a common topic in a set of filtered messages. If “snowboarding” is also identified as a topic in a set of filtered messages, snowboarding may also be included in a targeted marketing recommendation, even if “snowboarding” itself is not a common topic, based on the relationship with “skiing,” which is a common topic. Then, in block 621, the message analysis service 121 provides a targeted marketing recommendation that includes the topics that are discovered in the filtered messages and related to one or more of the previously identified topics. Thereafter, this portion of the execution of the message analysis service 121 ends as shown.

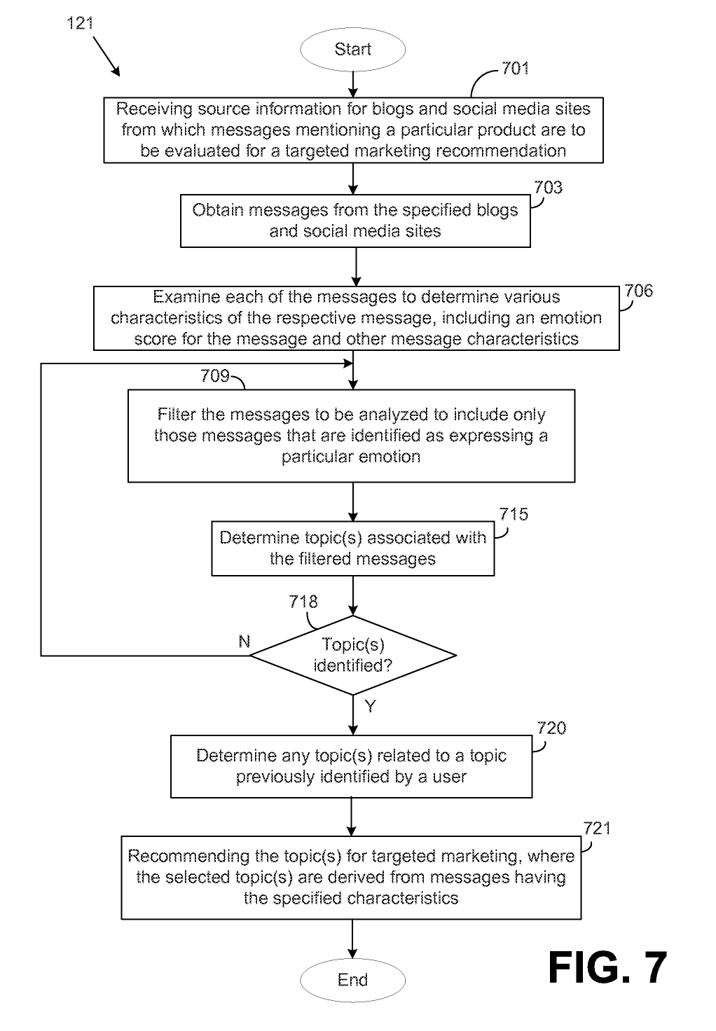

Referring next to FIG. 7, shown is a flowchart that provides still another example of the operation of a portion of the message analysis service 121 according to an embodiment. It is understood that the flowchart of FIG. 7 provides merely an example of the many different types of functional arrangements that may be employed to implement the operation of the portion of the message analysis service 121 as described herein. As an alternative, the flowchart of FIG. 7 may be viewed as depicting an example of elements of a method implemented in the server device 103 (FIG. 1) according to an embodiment.

This portion of the execution of the message analysis service 121 may be initiated in response to a request to produce a marketing recommendation for a particular product. Beginning with block 701, the message analysis service 121 receives source information (e.g. URIs) for network sites such as blogs, social media sites, etc. from which messages should be obtained. Then, in block 703, the message analysis service obtains the messages from the specified blogs and social media sites. As described previously, the source information may further include keywords, regular expressions, etc. that may be used to match or exclude particular messages from initial consideration for the marketing recommendation.

Next, in block 706, the message analysis service 121 then evaluates each of the selected messages to determine various characteristics of the respective message, such as an emotion score and other possible characteristics. The characteristics determined for individual ones of the messages may then be stored in the message metadata 133. Then, in block 709, the message analysis service 121 receives the desired characteristics limiting the messages to be analyzed to only those messages that have an emotion score indicating expression of a particular emotion and potentially other message characteristics. The desired characteristics may specified in the analytical rules 135 and/or user interface 129 of the messages of the messages to be analyzed. Thereafter, the message analysis service 121 may filter the selected messages based on the characteristics and/or other message metadata specified by the analytical rules 135 and/or user interface 129.

Continuing, in block 715, the message analysis service 121 begins the topic extraction operations upon the messages matching the desired characteristics through use of the k-means clustering algorithm and/or other natural language processing techniques. Next, in block 718, the message analysis service 121 determines whether topics were extracted during analysis of the filtered messages. If no topics were identified, then execution of the message analysis service 121 returns to block 709 where filter options may be adjusted. Alternatively, if topics were identified within the filtered messages, in block 720, the message analysis service 121 determines whether any of the topics are related to one or more previously identified topics. For example, a vendor may have one or more topics of particular interest such that they wish to be aware of any topics discovered that relate to these topics of interest. As a detailed example, the vendor may provide a topic of “snow sports.” If, during the topic discovery operations, the topic of “skiing” is found, the message analysis service 121 would recognize the relationship between “skiing” and the previously identified topic of “snow sports.”

Then, in block 721, the message analysis service 121 provides a targeted marketing recommendation that includes the topics that are discovered in the filtered messages and related to one or more of the previously identified topics. Thereafter, this portion of the execution of the message analysis service 121 ends as shown.

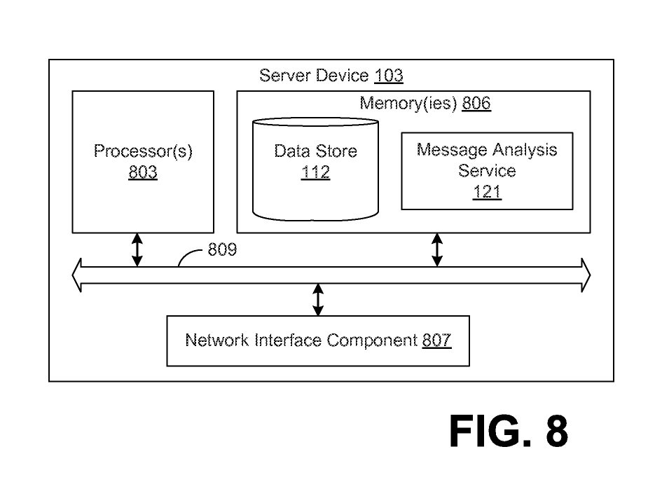

With reference to FIG. 8, shown is a schematic block diagram of the server device 103 according to an embodiment of the present disclosure. The server device 103 is representative of at least one server computer or like computing device, and includes at least one processor 803, a memory 806, and a network interface component 807, all of which are coupled to a local interface 809. The local interface 809 may comprise, for example, a data bus with an accompanying address/control bus or other bus structure as can be appreciated. The network interface component 807 enables the exemplary computing system to send and receive data via the network 109. The network interface component 807 may be implemented as an Ethernet interface, cellular radio, Wi-Fi™ transceiver and/or other type of network interface appropriate for a given type of network 109.

Stored in the memory 806 are both data and several components that are executable by the processor 803. In particular, stored in the memory 806 and executable by the processor 803 are the message analysis service 121, and potentially other applications. Also stored in the memory 806 may be a data store 112 and other data. In addition, an operating system may be stored in the memory 806 and executable by the processor 803.

It is understood that there may be other applications that are stored in the memory 806 and are executable by the processor 803 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 806 and are executable by the processor 803. In this respect, the term “executable” means a program file that is in a form that can ultimately be run by the processor 803. Examples of executable programs may be, for example, a compiled program that can be translated into machine code in a format that can be loaded into a random access portion of the memory 806 and run by the processor 803, source code that may be expressed in proper format such as object code that is capable of being loaded into a random access portion of the memory 806 and executed by the processor 803, or source code that may be interpreted by another executable program to generate instructions in a random access portion of the memory 806 to be executed by the processor 803, etc. An executable program may be stored in any portion or component of the memory 806 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 806 is defined herein as including both volatile and nonvolatile memory and data storage components. Volatile components are those that do not retain data values upon loss of power. Nonvolatile components are those that retain data upon a loss of power. Thus, the memory 806 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 803 may represent multiple processors 803 and/or multiple processor cores and the memory 806 may represent multiple memories 806 that operate in parallel processing circuits, respectively. In such a case, the local interface 809 may be an appropriate network that facilitates communication between any two of the multiple processors 803, between any processor 803 and any of the memories 806, or between any two of the memories 806, etc. The local interface 809 may comprise additional systems designed to coordinate this communication, including, for example, performing load balancing. The processor 803 may be of electrical or of some other available construction.

Although the message analysis service 121, the client application 141, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 3-7 show the functionality and operation of an implementation of portions of the message analysis service 121. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 803 in a computer system or other system. The machine code may be converted from the source code, etc. If embodied in hardware, each block may represent a circuit or a number of interconnected circuits to implement the specified logical function(s).

Although the flowcharts of FIGS. 3-7 show a specific order of execution, it is understood that the order of execution may differ from that which is depicted. For example, the order of execution of two or more blocks may be scrambled relative to the order shown. Also, two or more blocks shown in succession in FIGS. 3-7 may be executed concurrently or with partial concurrence. Further, in some embodiments, one or more of the blocks shown in FIGS. 3-7 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the message analysis service 121, that comprises software or code can be embodied in any non-transitory computer-readable medium for use by or in connection with an instruction execution system such as, for example, a processor 803 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the message analysis service 121, may be implemented and structured in a variety of ways. For example, one or more applications described may be implemented as modules or components of a single application. Further, one or more applications described herein may be executed in shared or separate computing devices or a combination thereof. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A method, comprising:
obtaining messages from a plurality of content sites accessible via a network;
filtering the messages using filter criteria to identify filtered messages having one or more characteristics relevant to an identified marketing circumstance;
selecting a topic based on determining that multiple occurrences of the filtered messages relate to the topic; and
based on selecting the topic, recommending the topic for targeted marketing in the identified marketing circumstance, the obtaining, filtering, selecting, and recommending performed by at least one computing device.

2. The method of claim 1, wherein selecting the topic further comprises determining that the topic is common in the filtered messages based on determining that multiple occurrences of the filtered messages relate to the topic.

3. The method of claim 2, wherein determining that the topic is common further comprises:
identifying potential topics based on determining that one or more of the filtered messages relate to each of the potential topics; and
determining that the topic is common based on determining that the occurrences of filtered messages that relate to the topic are greater than occurrences of filtered messages that relate to another topic of the potential topics.

4. The method of claim 2, wherein determining that the topic is common is based on determining that the occurrences of filtered messages that relate to the topic exceed a threshold.

5. The method of claim 1, wherein selecting the topic further comprises:
identifying potential topics based on determining that one or more of the filtered messages relate to each of the potential topics; and
selecting the topic from the potential topics based on the topic being similar to a previously-identified topic for the identified marketing circumstance.

6. The method of claim 1, further comprising:
determining whether each message has either a positive or a negative semantic score by analyzing content of each message,
wherein filtering the messages comprises filtering the messages based on semantic score being positive or negative.

7. The method of claim 1, further comprising:
determining an emotional score by analyzing content of each message, wherein the emotion score identifies one or more emotions for each respective message,
wherein filtering the filtered messages out of the messages is accomplished by identifying messages based on emotion score.

8. The method of claim 1, further comprising providing an interface for:
receiving the filter criteria; and
displaying the topic determined to be common in the filtered messages.

9. The method of claim 1, further comprising providing an interface for displaying multiple topics, each of the multiple topics determined to be common in the filtered messages.

10. The method of claim 1, further comprising identifying the one or more characteristics of the messages using natural language processing performed upon content of the messages.

11. The method of claim 1, wherein the topic is determined by a k-means clustering algorithm applied to content of the filtered messages.

12. The method of claim 1, wherein providing the particular marketing recommendation comprises providing the topic for use as a subject of a marketing campaign.

13. A non-transitory computer-readable medium comprising a program executable in a computing device, the program comprising code that when executed by a processor causes the computing device to:
obtain messages from a plurality of content sites accessible via a network;
filter the messages using filter criteria to identify filtered messages having one or more characteristics relevant for a particular marketing circumstance;
select a topic based on determining that multiple occurrences of the filtered messages relate to the topic; and
based on selecting the topic, recommend the topic for targeted marketing in the identified marketing circumstance.

14. The non-transitory computer-readable medium of claim 13, wherein the topic is determined by a k-means clustering algorithm applied to the filtered messages.

15. The non-transitory computer-readable medium of claim 13, wherein the code to select the topic further comprises code to determine that the topic is common in the filtered messages based on determining that multiple occurrences of the filtered messages relate to the topic.

16. The non-transitory computer-readable medium of claim 13, wherein the program further comprises code to provide an interface for displaying multiple topics, each of the multiple topics identified as being associated with one or more of the filtered messages.

17. The non-transitory computer-readable medium of claim 13, wherein the code to select the topic further comprises code to:
identify potential topics based on determining that one or more of the filtered messages relate to each of the potential topics; and
select the topic from the potential topics based on the topic being similar to a previously-identified topic for the identified marketing circumstance.

18. A system, comprising:
a computing device; and
a message analysis service executed in the computing device, the message analysis service comprising logic that:
obtains messages from a plurality of content sites accessible via a network;
filters the messages using filter criteria to identify filtered messages having one or more characteristics relevant to a particular marketing circumstance; and
selects a topic based on determining that multiple occurrences of the filtered messages relate to the topic; and
based on selecting the topic, recommends the topic for targeted marketing in the identified marketing circumstance.

19. The system of claim 18, wherein the one or more characteristics comprise at least one of: a sentiment score, an emotion score, and a detected language.

20. The system of claim 18, further comprising logic that determines that the topic is common in the filtered messages based on determining that multiple occurrences of the filtered messages relate to the topic.

21. The system of claim 18, wherein the logic that selects the topic further comprises logic that:
identifies potential topics based on determining that one or more of the filtered messages relate to each of the potential topics; and
selects the topic from the potential topics based on the topic being similar to a previously-identified topic for the identified marketing circumstance.
